(19) United States
(12) Patent Application Publication
(10) Pub. No.: US 2011/0109846 A1
(43) Pub. Date: May 12, 2011

(54) Liquid crystal display with inspection structures for polarizer alignment

(75) Inventor: Chien-Ta Liao, Taoyuan County (TW)

(73) Assignee: CHUNGHWA PICTURE TUBES, LTD., Taoyuan County (TW)

(21) Appl. No.: 12/659,787

(22) Filed: Mar. 22, 2010

(30) Foreign Application Priority Data
Nov. 9, 2009 (TW) 098220742

(51) Int. Cl. G02F 1/1335

(52) U.S. Cl. 349/96

(57) ABSTRACT

The present invention discloses a liquid crystal display having inspection structures for polarizer alignment. The liquid crystal display comprises: a first glass substrate and a second glass substrate, which include inspection structures for polarizer alignment respectively to improve the alignment accuracy; a liquid crystal layer disposed between a side of the first and a side of the second glass substrates; and a first polarizer and a second polarizer attached on another side of the first glass substrate and another side of the second glass substrate respectively, wherein the another sides are opposing to the liquid crystal layer. Then, a magnifying device is utilized to inspect the location of the inspection structures for detecting the accuracy degree of the polarizer alignment.

### FIELD OF THE INVENTION

The present invention relates to a liquid crystal display (LCD), and more particularly to a liquid crystal display with a plurality of inspection structures for polarizer alignment.

### BACKGROUND OF THE INVENTION

In recent years, with the development of the electronic technology, the requirements of small volume and low power consumption to a display are continuously demanding day by day. It is because that the liquid crystal displays (LCD) may offer several advantages, such as low power consumption, low heat, and light weight, they are usually employed and equipped to electronic products and have replaced cathode ray tube (CRT) display progressively.

Regarding to FIG. 1, it shows a structure diagram of a traditional liquid crystal panel. The liquid crystal panel 100 sequentially includes a first polarizer 101, a first glass substrate 103, a liquid crystal layer 105, a second glass substrate 107, and a second polarizer 109. The liquid crystal layer 105 is constructed by liquid crystal material disposed between the first glass substrate 103 and the second glass substrate 107, and liquid crystal material is held in vacuum state by a seal (not shown). A thin film transistor (TFT) layer 111 is disposed on a surface of the first glass substrate 103 facing to the liquid crystal layer 105, and a color filter 113 is disposed on a surface of the second glass substrate 107 facing to the liquid crystal layer 105. The first polarizer 101 and the second polarizer 109 are attached on the outsides of the first glass substrate 103 and the second glass substrate 107 respectively, and the first polarizer 101 and the second polarizer 109 are organized to allow only single-polarized light pass there-through to adjust the polarization of the light.

As shown in FIG. 1, a non-polarized light is illumined from a backlight module 120 and passed through the first polarizer 101 for polarizing the light to enter the first glass substrate 103 and the liquid crystal layer 105 with a predetermined polarization. The liquid crystal cells in the liquid crystal layer 105 got the retardation would be twisted after being driven by applied voltage difference, so as to allow the light pass partial of the liquid crystal layer 105, and the others will not allow the light pass. After passing through the liquid crystal layer 105, the light will pass through the color filter 113 for obtaining the desired colors. Finally, the second glass substrate 108 and the second polarizer 109 will be penetrated through by the light. After passing through the second polarizer 109, the light will be polarized to vertical polarized light. Therefore, the light from the liquid crystal panel 100 let a user who is in front of the liquid crystal display watch the displaying image clearly.

As mentioned-above, if the polarizer alignment between the first polarizer 101 attached on the first glass substrate 103 and the second polarizer 109 attached on the second glass substrate 107 are miss-alignment, it will cause that the non-polarized light from the backlight module fails to enter accurately to the liquid crystal layer 105 or results that the light outputted from the color filter 113 isn't a correct polarized light, thereby affecting the optical characteristics of the liquid crystal panel 100. Thus, the inspection of the polarizer alignment of the first polarizer 101 and the second polarizer 109 is an essential step after attaching the first polarizer 101 and the second polarizer 109 on the first glass substrate 103 and the second glass substrate 107 during the fabricating process of liquid crystal displays.

Traditionally, the inspection of the polarizer alignment between the first polarizer 101 and the second polarizer 109 is performed by an operator to randomly pick some liquid crystal panels up after attaching the polarizer, and to manually inspect these liquid crystal panels by an optical microscope. Regarding to FIG. 2, the above inspecting method is introduced to show how the operator uses the optical microscope to measure two points, for instant, the point A1 and point A2, point B1 and point B2, point C1 and point C2, or point D1 and D2 of the liquid crystal panel with attached polarizer in horizontal and in vertical directions, respectively. Sequentially, the two measured points are calculated for inspecting the polarizer alignment of the polarizer attached on the liquid crystal panel to determine whether the specification requirement is fulfilled or not. This conventional method requires measured data obtained by using the optical microscope, subsequently, the measured data is calculated for determining whether the specification of polarizer alignment is fit or not. Therefore, this traditional method needs large amount of manpower, thereby increasing the production cost if proceeding blanket and comprehensive inspection of the polarizer alignment. The method also raises a risk to production by sampling inspection, namely, only some of the liquid crystal displays are inspected, it leads to that the failure production with non-satisfied polarizer alignment will not be found, immediately, thereby resulting the failure display are manufactured.

In order to solve the foregoing problems, what is needs is an instant inspection method and structure for a liquid crystal display polarizer alignment. Therefore, the quality of liquid crystal displays can be guaranteed by the blanket inspection, and the manpower is saved and the throughput is also increased effectively.

### SUMMARY OF THE INVENTION

An object of the present invention is to solve the problem of the traditional liquid crystal display inspection method which fails to inspect the specification of the polarizer alignment instantly and comprehensively.

Another object of the present invention is to prevent the liquid crystal displays with failure optical characteristics from being made by instantly and entirely inspect the polarizer alignment of the liquid crystal panel, which cannot be achieved by the conventional way that fails to fulfill the requirement of the industry.

Still another object of the present invention is to reduce manpower cost and inspecting cycle time during the inspecting process of the polarizer alignment of the liquid crystal panel to improve the traditional inspecting method of polarizer alignment which involves several complicated process to measure data by an optical microscope and followed by calculating the measured data for inspecting.

In order to reach above-mentioned object, the present invention provides a liquid crystal display having inspection structure for polarizer alignment, comprising: a first glass substrate and a second glass substrate including at least one inspection structure for the polarizer alignment formed thereon, respectively; a liquid crystal layer disposed between a first side of the first glass substrate and a first side of the second glass substrate; and a first polarizer and a second polarizer attached on a second side of the first glass substrate and a second side of the second glass substrate, wherein the second sides are opposing to the liquid crystal layer. Then, a magnifying device is utilized to inspect the location of the inspection structures for detecting the accuracy degree of the polarizer alignment after the first polarizer and the second polarizer have attached.

In certain preferred embodiments, the inspection structures are disposed on a non-display region (or called black matrix) of the liquid crystal display. In another certain embodiments, the first glass substrate and the second glass substrate comprise four inspection structures of polarizer alignment respectively; and the four inspection structures are disposed on the four corners of the first glass substrate and the second glass substrate respectively. In still another certain embodiments, the inspection structure is constructed by three rectangular structures with side by side configuration, and the three rectangular structures represent a maximum region, a typical region, and a minimum region respectively for detecting the accuracy degree of polarizer alignment.

The present invention also provides a liquid crystal display having inspection structure for polarizer alignment, comprising: a first glass substrate and a second glass substrate including at least one first inspection structure for the polarizer alignment formed thereon, respectively; a liquid crystal layer, which disposes between a first side of the first glass substrate and a first side of the second glass substrate; and a first polarizer and a second polarizer having at least one second inspection structure which are corresponding to the first inspection structure for polarizer alignment, and attached on a second side of the first glass substrate and a second side of the second glass substrate, wherein the second sides are opposing to said liquid crystal layer.

In certain preferred embodiments, the first inspection structures and the second inspection structures are disposed on a non-display region (or called black matrix) of the liquid crystal display. In another certain embodiments, the first glass substrate and the second glass substrate comprise four inspection structures of polarizer alignment respectively; and the four inspection structures are disposed on the four corners of the first glass substrate and the second glass substrate respectively. In still another certain embodiments, the first inspection structure comprises a target structure constructed by a cross structure encircled a circle; and the second inspection structure comprises any geometry structure, such as a circle structure or a square structure, etc.

The advantages of the present invention include providing a liquid crystal display which can be instantly inspected to determine whether the specification of polarizer alignment of the polarizer is fulfilled or not. Moreover, the inspecting method only involves a magnifying device to reach the object of the present invention. Thus, the optical stability and characteristics of the liquid crystal display can be guaranteed without large manpower by inspecting comprehensively and instantly after the attaching process of polarizer on the liquid crystal panel.

A detailed description is given in the following embodiments and with reference to the accompanying drawings and claims.

### BRIEF DESCRIPTION OF THE DRAWINGS

FIG. 1 shows a diagram of a liquid crystal panel structure of a traditional liquid crystal display.

FIG. 2 shows a diagram of a traditional inspecting method of polarizer alignment by an optical microscope.

FIG. 3 shows a structure diagram of a liquid crystal display with inspection structures according to the present invention.

FIGS. 4A˜B show diagrams of one embodiment of inspection structures according to the present invention.

FIGS. 5A˜C show diagrams of another embodiment of inspection structures according to the present invention.

FIG. 6 shows a diagram of the display region and non-display region of the liquid crystal panel of the liquid crystal display according to the present invention.

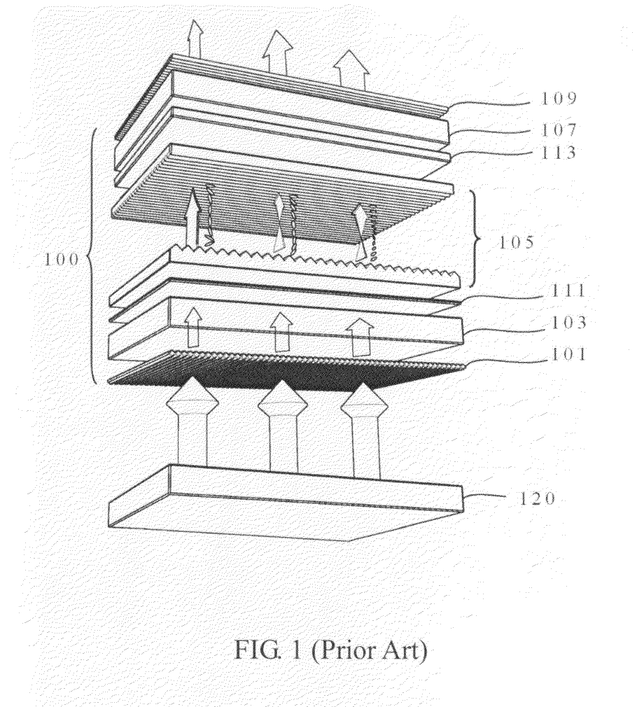

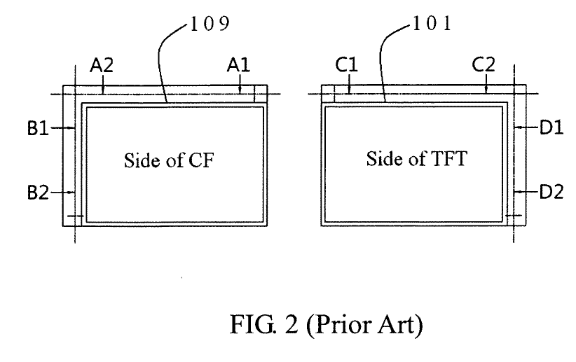

### DETAILED DESCRIPTION OF THE PREFERRED EMBODIMENT

The invention hereinafter will be described in greater detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Further, the scope of the present invention is expressly not limited to any particular embodiments except what is specified in the appended claims.

The present invention and embodiments now are described in detail. In diagrams and descriptions as below, the same symbols are utilized to represent the same or similar elements. The main of features of the embodiments of the present invention are described in highly simplified illustration. Otherwise, the drawings of the present invention do not depict every characteristic of the actuality embodiments, and all elements of the drawings are not depicted in proportional size but in relative size.

The present invention is to provide a liquid crystal display having inspection structure for polarizer alignment to improve the alignment accuracy. Each liquid crystal display with attached polarizer could be inspected comprehensively, and a precision instrument such as optical microscope is not required for saving manpower and cycle time effectively.

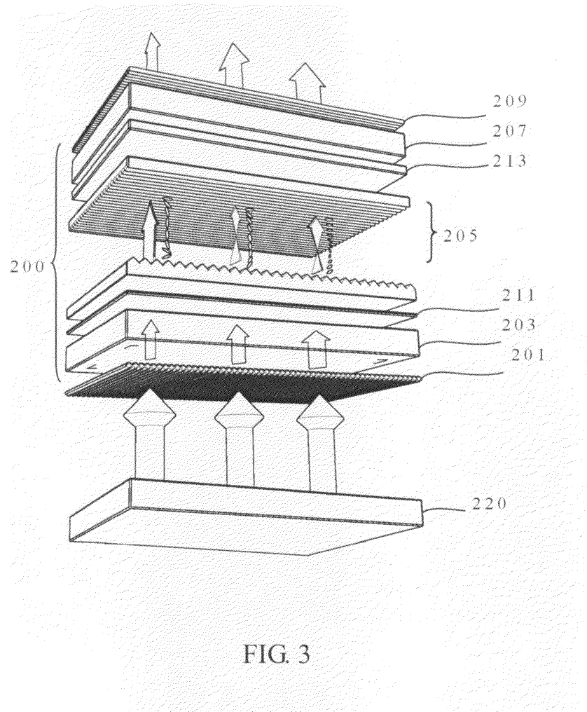

Regarding to FIG. 3, it shows a diagram of a liquid crystal panel with an inspection structure for polarizer alignment according to the present invention. The liquid crystal panel 200 sequentially includes a first polarizer 201, a first glass substrate 203, a liquid crystal layer 205, a second glass substrate 207, and a second polarizer 209. The liquid crystal layer 205 includes liquid crystal material disposed between the first glass substrate 203 and the second glass substrate 207 in a sandwich structure, and the liquid crystal material are maintained in vacuum state by a seal (not shown). A thin film transistor layer 211 is disposed on a surface of the first glass substrate 203 facing to the liquid crystal layer 205, and a color filter 213 is disposed on a surface of the second glass substrate 207 facing to the liquid crystal layer 205. The first polarizer 201 and the second polarizer 209 are attached on the exterior surface of the first glass substrate 203 and the second glass substrate 207 respectively, and are utilized to allow certain polarized light paths through. In preferred embodiments of the present invention, a plurality of inspection structures disposed on the first glass substrate 203 and the second glass substrate 207. In another preferred embodiments of the present invention, not only the first glass substrate 203 and the second glass substrate 207 have these inspection structures, but also a plurality of inspection structures are formed on the first polarizer 201 and the second polarizer 209, these inspection structures are corresponding to the plurality of inspection structures on the first and second glass substrates 203, 207.

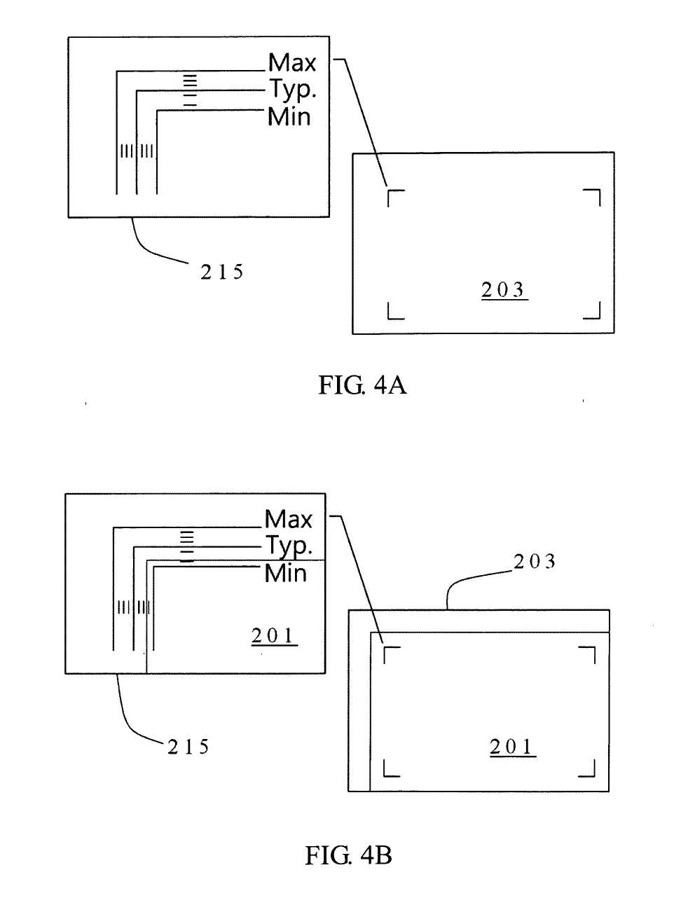

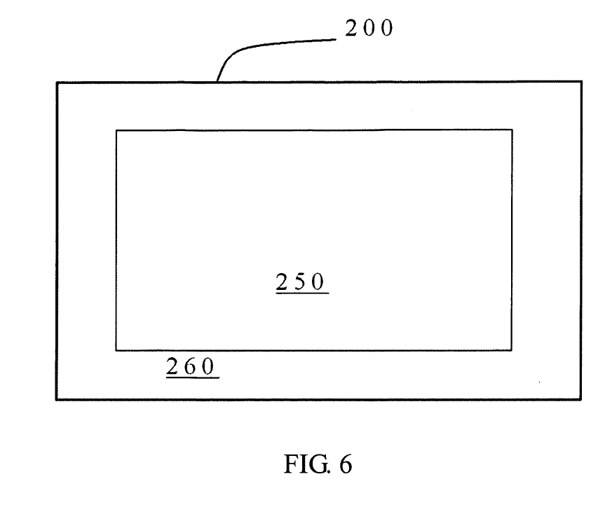

Subsequently, turning to FIGS. 4A˜C, which show diagrams of one embodiment according to the present invention. In here, the present invention is utilized the first glass substrate 203 attached the first polarizer 201 to illustrate, but not to limit the scope of the present invention. Regarding to FIG. 6, a liquid crystal panel 200 is divided to a display region 250 and a non-display region 260 (or called a black matrix). In certain embodiments of the present invention, a plurality of inspection structures 215 are fabricated on the first glass substrate 203, and the inspection structures 215 are fabricated on the non-display region 260 of the liquid crystal panel 200 to avoid effecting the display of the liquid crystal panel. In the preferred embodiment, these inspection structures 215 are fabricated at the four corners of the first glass substrate 203. Subsequently, referring to FIG. 4A, in this embodiment, the inspection structure 215 is constructed by three rectangular structures and arranged in side by side configuration, and the three rectangular structures represent a maximum region (Max), a typical region (Typ.), and a minimum region (Min) respectively. After the first polarizer 201 is attached on the first glass substrate 203, please refer to FIG. 4B, only a magnifying device, such as a magnifier, is required to inspect the location of the inspection structure to determine whether the polarizer alignment of the first polarizer 201 attached on the first glass substrate 203 fulfills the requirement or not. The maximum region and the minimum region are utilized to define tolerance of the polarizer alignment. It means that the polarizer alignment is not satisfied if the polarizer exceeds over the maximum region or the minimum region after the polarizer is attached on glass substrate. Thus, the polarizer should be removed and reattached on the glass substrate to guarantee the optical characteristics and stability of the liquid crystal display. In this embodiment, the typical region indicates the proper location for the polarizer attaching on the glass substrate.

After the polarizer is attached on the glass substrate, only a simply magnifying device is required to identify whether the alignment of the polarizer fulfills the requirement or not. Therefore, the present invention offers a blank inspection method and scheme and, consequently, the alignment of the polarizer can be fulfilled the requirement of the specification, thereby maintains the optical stability and characteristics of all liquid crystal panel.

Although these inspection marks (substrates) 215 are set at the four corners, for a person having ordinary skill in the art, he should understand that the number of the inspection marks should be altered and not limited to four. One, two, three, or more inspection marks may be utilized to the liquid crystal display of the present invention for reaching the same effect.

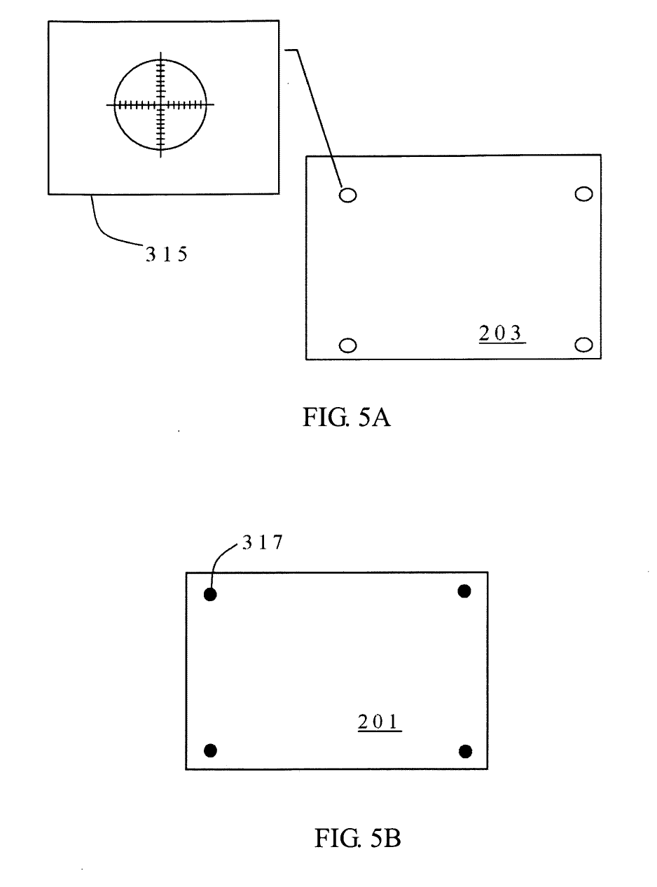

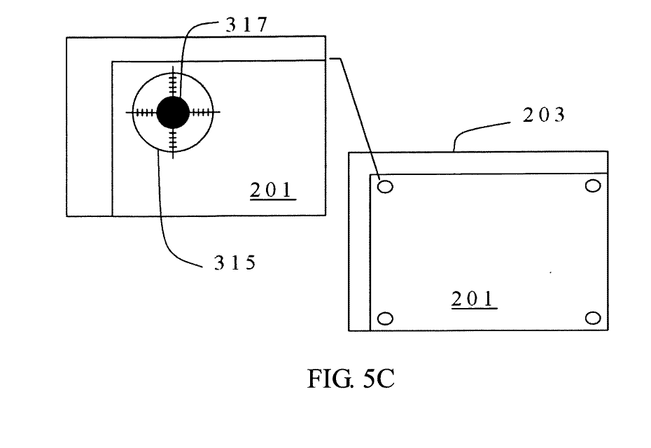

Sequentially, regarding to FIGS. 5A˜C, which show diagrams of another embodiment according to the present invention. In here, the present invention utilizes the first glass substrate 203 having the first polarizer 201 for illustration, but not limited to the embodiment. Referring to FIG. 5A and FIG. 5B, a first inspection structure 315 is fabricated on the first glass substrate 203 and a second inspection structure 317 is fabricated on the second glass substrate 317. In this embodiment, the first inspection structure 315 and the second inspection structure 317 are both formed on the non-display region of the liquid crystal panel so that the display of the liquid crystal panel wouldn't be affected. In this embodiment, the first inspection structures 315 are fabricated at the four corners of the first glass substrate 203, and the second inspection structures 317 are fabricated on the first polarizer 201 corresponding to the four corners of the first inspection structures 315. Regarding to FIG. 5C, in this embodiment, the first inspection structure comprises a target structure constructed by a cross configuration encircled by a circle, and the second inspection structure comprises a circle structure. After the polarizer 201 is attached on the first glass substrate 203, the alignment of the first polarizer 201 is fulfilled if the second inspection structure 317 is encircled by the first inspection structure 315. On the contrary, the alignment is fail. Thus, the polarizer should be tore and reattached on the glass substrate to guarantee the quality of the liquid crystal display.

Although the second inspection 317 in this embodiment is configured to a circle structure for instructing, for a person having ordinary skill in the art, he should understand that the second inspection 317 can be modified into any shape, such as a square shape or any geometry shape.

Otherwise, although the first inspection structures 315 and the second inspection structures 317 are disposed at the four corners of the first glass substrate 203 and the first polarizer 201, for a person having ordinary skill in the art, he should understand that the number of the inspection structures according to the present may be alter, and not limit to four. Any number, such as two, three, or more inspection structures may be utilized to the liquid crystal display of the present invention.

Moreover, these inspection structures according to the present invention can be designed on the same optical mask for making the thin film transistor or the color filter. Thus, the inspection structures can be simultaneously fabricated with the thin film transistor or the color filter on the glass substrate so that there is no any extra process for the fabricating process of the liquid crystal display. Although the first glass substrate 203 and the first polarizer 201 are used for an example to illustrate the embodiment of the present invention, for a person having ordinary skill in the art, he should understand that these inspection structures according to the present invention also can be utilized to on the second glass substrate 207 and the second polarizer 209.

As mentioned-above, the liquid crystal display having inspection structure for polarizer alignment according to the present invention only involves a simply magnifying device to inspect whether the specification of the polarizer alignment is fulfilled or not so that large amount of manpower is omitted. Otherwise, the inspecting process of polarizer alignment of the liquid crystal panel can be performed instantly on the production line, and every liquid crystal panel with the polarizer can be inspected for making sure the optical quality of the liquid crystal display. Furthermore, the inspection structures can be designed on the optical mask of thin film transistor or color filter, and may be simultaneously fabricated on the glass substrate during the formation of the thin film transistor or the color filter. No additional process is required to the fabricating process of the liquid crystal display.

Moreover, the specification of polarizer alignment of the liquid crystal display with inspection structure according to the present invention can be inspected immediately and accurately, and doesn't need a precision instrument such as an optical microscope. Therefore, the cost of manpower and the inspecting time are saved effectively.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A liquid crystal display having inspection structure for polarizer alignment, comprising:
a first glass substrate and a second glass substrate, including at least one inspection structure for said polarizer alignment formed thereon, respectively;
a liquid crystal layer disposed between a first side of said first glass substrate and a first side of said second glass substrate; and
a first polarizer attached on a second side of said first glass substrate and a second polarizer attached a second side of said second glass substrate, wherein said second sides of said first glass substrate and said second glass substrate are opposing to said liquid crystal layer.

2. The liquid crystal display according to claim 1, wherein said liquid crystal display has a non-display region, and said at least one inspection structure is disposed on said non-display region.

3. The liquid crystal display according to claim 1, wherein said first and second glass substrates have four said inspection structures respectively.

4. The liquid crystal display according to claim 3, wherein said inspection structures are disposed at four corners of said first and second glass substrates.

5. The liquid crystal display according to claim 1, wherein said inspection structure is constructed by three rectangular structures with a side by side configuration.

6. The liquid crystal display according to claim 5, wherein side three rectangular structures represent a maximum region, a typical region, and a minimum region respectively for detecting the accuracy degree of polarizer alignment.

7. The liquid crystal display according to claim 1, wherein said inspection structure is inspected by a magnifying device for detecting the accuracy degree of polarizer alignment.

8. A liquid crystal display having inspection structure for polarizer alignment, comprising:
a first glass substrate and a second glass substrate, which include at least one first inspection structure for said polarizer alignment formed thereon, respectively;
a liquid crystal layer, which disposes between a first side of said first glass substrate and a first side of said second glass substrate; and
a first polarizer having at least one second inspection structure corresponding to said first inspection structure for polarizer alignment and attached on a second side of said first glass substrate, and a second polarizer also having at least one second inspection and attached a second side of said second glass substrate, wherein said second sides of said first glass substrate and said second glass substrate are opposing to said liquid crystal layer.

9. The liquid crystal display according to claim 8, wherein said liquid crystal display has a non-display region, and said at least one first inspection structure and said at least one second inspection structure are disposed on said non-display region.

10. The liquid crystal display according to claim 8, wherein said first and second glass substrates have four said first inspection structures respectively.

11. The liquid crystal display according to claim 10, wherein said first inspection structures are disposed at four corners of said first and second glass substrates.

12. The liquid crystal display according to claim 10, wherein said first inspection structure comprises a target structure constructed by a cross structure encircled a circle.

13. The liquid crystal display according to claim 12, wherein said second inspection structure comprises any geometry structure.

14. The liquid crystal display according to claim 13, wherein said second inspection structure comprises a circle structure.

15. The liquid crystal display according to claim 13, wherein said second inspection structure comprises a square structure.

16. The liquid crystal display according to claim 8, wherein said inspection structure could be inspected detected by a magnifying device for detecting the accuracy degree of polarizer alignment.
